(19) United States
(12) Patent Application Publication
(10) Pub. No.: US 2021/0226371 A1
(43) Pub. Date: Jul. 22, 2021

(54) Electrical Plug Locking Device

(71) Applicant: Benjamin Harper, JR., Gary, IN (US)

(72) Inventor: Benjamin Harper, JR., Gary, IN (US)

(21) Appl. No.: 16/747,190

(22) Filed: Jan. 20, 2020

(51) Int. Cl. H01R 13/44; H01R 13/516

(52) U.S. Cl. CPC H01R 13/44; H01R 24/28; H01R 13/516

(57) ABSTRACT

An electrical plug locking device for preventing unauthorized use of an electrical device includes a housing, which defines an interior space. The housing comprises a pair of sections, which are hingedly engaged so that the housing is selectively positionable in a closed configuration and an open configuration. A first end of the housing has a cutout positioned therein that allows insertion of a cable of a power cord concurrently with a plug of the power cord being positioned between the sections. A user is positioned to hinge the sections to the closed configuration so that the plug is positioned in the interior space. A lock assembly is engaged to the housing and is positioned to selectively secure the housing in the closed configuration to prevent unauthorized use of an electrical device that powered through the power cord.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to locking devices and more particularly pertains to a new locking device for preventing unauthorized use of an electrical device.

### (2) Description of Related Art Including Information Disclosed Under 37 CFR 1.97 and 1.98

The prior art relates to locking devices that secure electrical devices from unauthorized use. Prior art locking devices may comprise devices that engage the prongs of a plug or devices with slidably closable shells that enclose the plug.

### BRIEF SUMMARY OF THE INVENTION

An embodiment of the disclosure meets the needs presented above by generally comprising a housing, which defines an interior space. The housing comprises a pair of sections, which are hingedly engaged so that the housing is selectively positionable in a closed configuration and an open configuration. A first end of the housing has a cutout positioned therein. The cutout is configured to allow insertion of a cable of a power cord concurrently with a plug of the power cord being positioned between the sections. A user is positioned to hinge the sections to the closed configuration so that the plug is positioned in the interior space. A lock assembly is engaged to the housing and is positioned to selectively secure the housing in the closed configuration to prevent unauthorized use of an electrical device that is powered through the power cord.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an electrical plug locking device according to an embodiment of the disclosure in a closed configuration.

FIG. 2 is an isometric perspective view of an embodiment of the disclosure in an open configuration.

FIG. 3 is an isometric perspective view of an embodiment of the disclosure.

FIG. 4 is a front view of an embodiment of the disclosure.

FIG. 5 is a side view of an embodiment of the disclosure.

### DETAILED DESCRIPTION OF THE INVENTION

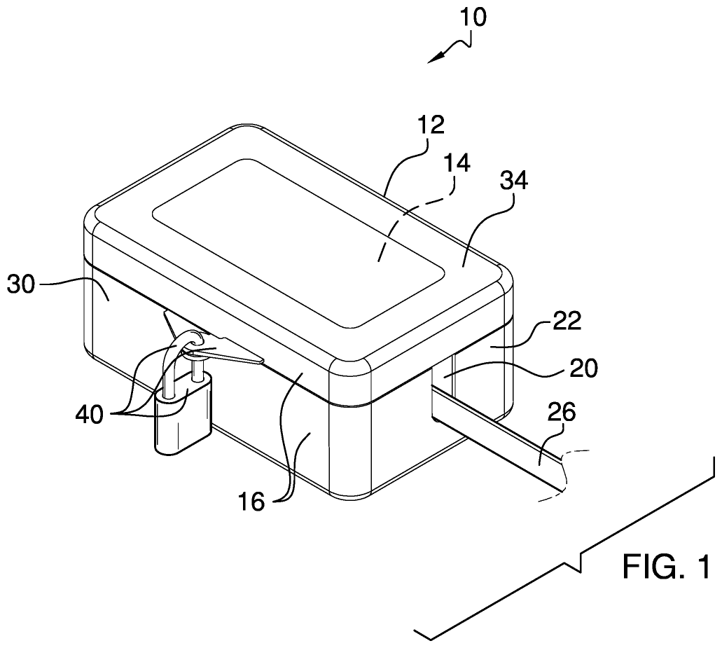

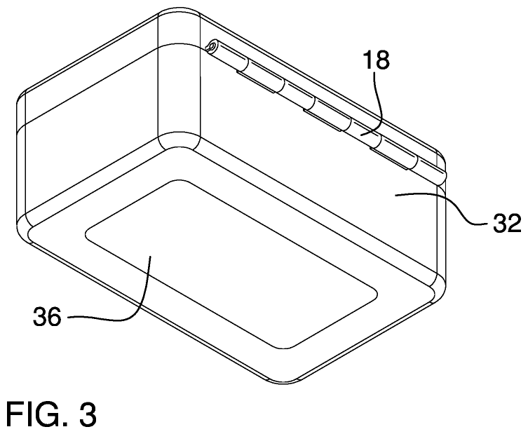

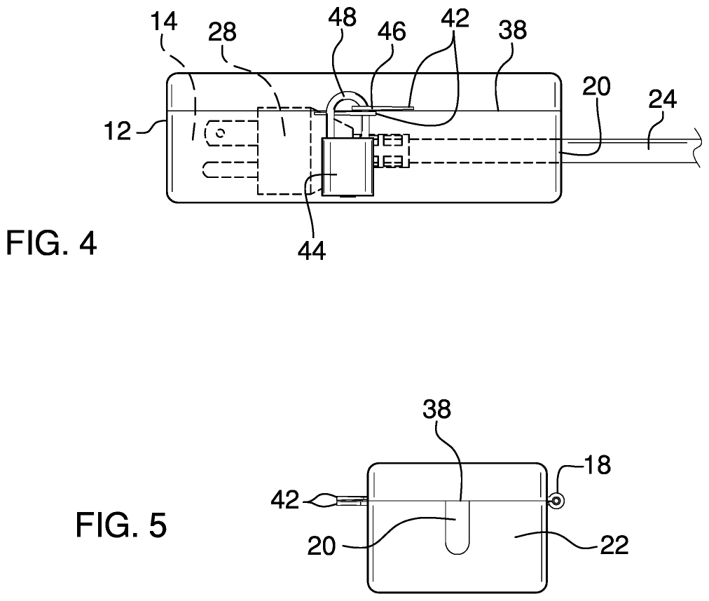

With reference now to the drawings, and in particular to FIGS. 1 through 5 thereof, a new locking device embodying the principles and concepts of an embodiment of the disclosure and generally designated by the reference numeral 10 will be described.

As best illustrated in FIGS. 1 through 5, the electrical plug locking device 10 generally comprises a housing 12, which defines an interior space 14. The housing 12 comprises a pair of sections 16, which are hingedly engaged so that the housing 12 is selectively positionable in a closed configuration and an open configuration. The housing 12 may be substantially rectangularly box shaped, or alternatively shaped, such as, but not limited to, spherically shaped, ovoidal shaped, and the like.

A hinge 18 is engaged to and extends between the sections 16 of the pair of sections 16 so that the housing 12 is selectively positionable in the closed configuration and the open configuration. The hinge 18 may be continuous type, or other type, such as, but not limited to, barrel type, concealed type and the like.

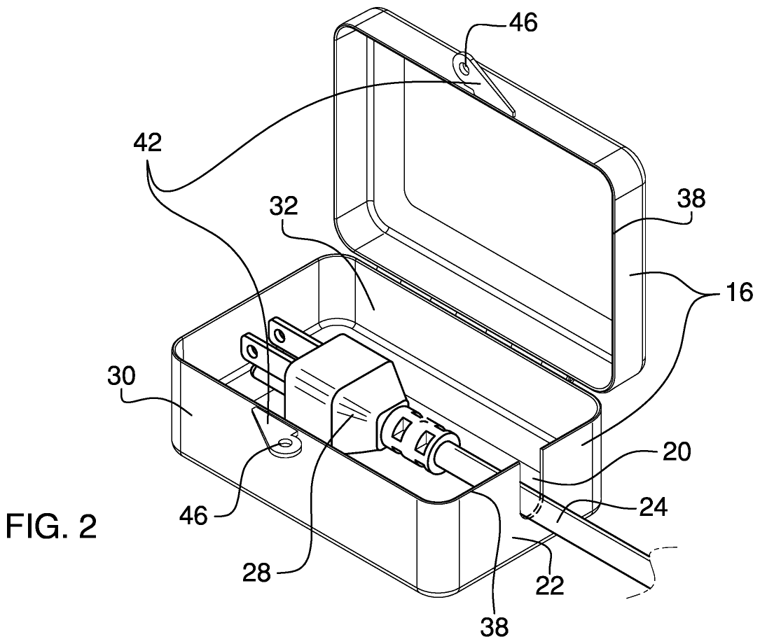

A first end 22 of the housing 12 has a cutout 20 positioned therein. The cutout 20 is configured to allow insertion of a cable 24 of a power cord 26 concurrently with a plug 28 of the power cord 26 being positioned between the sections 16, as shown in FIG. 2. A user is positioned to hinge the sections 16 to the closed configuration so that the plug 28 is positioned in the interior space 14, as shown in FIG. 1.

As shown in FIG. 5, the cutout 20 is positioned equally distant from a front 30 and a back 32 of the housing 12 and substantially equally distant from a top 34 and a bottom 36 of the housing 12. The cutout being positioned as such allows the plug 28 to be substantially centrally positioned within the interior space 14. The cutout 20 is substantially U-shaped and extends into a respective section 16 from a perimeter 38 of the respective section 16. The perimeter 38 is positioned between the top 34 and the bottom 36 of the housing 12. The cutout 20 being substantially U-shaped protects the cable 24 from being damaged.

A lock assembly 40 is engaged to the housing 12 and is positioned to selectively secure the housing 12 in the closed configuration to prevent unauthorized use of an electrical device that is powered through the power cord 26. The housing 12 also protects the plug 28 from damage.

The lock assembly 40 may comprise a pair of tabs 42 and a padlock 44, or other locking means, such as, but not limited to, pin tumbler locks, cam locks, and the like. Each tab 42 is coupled to and extends from a respective section 16 proximate to the perimeter 38 of the respective section 16. Each tab 42 has a hole 46 positioned therethrough so that the holes 46 are aligned when the housing 12 is positioned in the closed configuration. The padlock 44 comprises a shackle 48, which is positioned to be inserted through the holes 46 to secure the housing 12 in the closed configuration.

In use, the cable 24 of a power cord 26 is positioned in the cutout 20 concurrently with the plug 28 of the power cord 26 being positioned between the sections 16. The user then hinges the sections 16 to the closed configuration. The shackle 48 of the padlock 44 is inserted through the holes 46 to secure the housing 12 in the closed configuration.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. An electrical plug locking device comprising:
a housing defining an interior space, the housing comprising a pair of sections, the sections being hingedly engaged such that the housing is selectively positionable in a closed configuration and an open configuration, the housing having a single cutout such that the single cutout defines an only opening into the interior space when the sections are in the closed configuration, a first end of the housing having the cutout positioned therein, wherein the cutout is configured for insertion of a cable of a power cord concurrently with a plug of the power cord being positioned between the sections facilitating manipulation of the sections to the closed configuration, such that the plug is positioned in the interior space; and
a lock assembly engaged to the housing such that the lock assembly is positioned for selectively securing the housing in the closed configuration.

2. The electrical plug locking device of claim 1, wherein the housing is substantially rectangularly box shaped.

3. The electrical plug locking device of claim 1, further including a hinge engaged to and extending between the sections of the pair of sections such that the housing is selectively positionable in the closed configuration and the open configuration.

4. The electrical plug locking device of claim 3, wherein the hinge is continuous type.

5. The electrical plug locking device of claim 1, wherein the cutout is positioned equally distant from a front and a back of the housing and when in the closed configuration, the cutout is substantially equally distant from a top and a bottom of the housing.

6. The electrical plug locking device of claim 5, wherein the cutout is substantially U-shaped, the cutout extending into a respective section from a perimeter of the respective section positioned between the top and the bottom of the housing.

7. The electrical plug locking device of claim 6, wherein the lock assembly comprises a pair of tabs and a padlock, each tab being coupled to and extending from a respective section proximate to the perimeter, each tab having a hole positioned therethrough such that the holes are aligned when the housing is positioned in the closed configuration, the padlock comprising a shackle such that the shackle is positioned for insertion through the holes for securing the housing in the closed configuration.

8. A power cord and electrical plug locking device combination comprising:
a power cord operationally coupled to an electrical device;
a housing defining an interior space, the housing comprising a pair of sections, the sections being hingedly engaged such that the housing is selectively positionable in a closed configuration and an open configuration, the housing having a single cutout such that the single cutout defines an only opening into the interior space when the sections are in the closed configuration, a first end of the housing having the cutout positioned therein, wherein the cutout is configured for insertion of a cable of the power cord concurrently with a plug of the power cord being positioned between the sections facilitating manipulation of the sections to the closed configuration, such that the plug is positioned in the interior space; and
a lock assembly engaged to the housing such that the lock assembly is positioned for selectively securing the housing in the closed configuration.

9. The power cord and electrical plug locking device combination of claim 8, wherein the housing is substantially rectangularly box shaped.

10. The power cord and electrical plug locking device combination of claim 8, further including a hinge engaged to and extending between the sections of the pair of sections such that the housing is selectively positionable in the closed configuration and the open configuration.

11. The power cord and electrical plug locking device combination of claim 10, wherein the hinge is continuous type.

12. The power cord and electrical plug locking device combination of claim 8, wherein the cutout is positioned equally distant from a front and a back of the housing and substantially equally distant from a top and a bottom of the housing.

13. The power cord and electrical plug locking device combination of claim 12, wherein the cutout is substantially U-shaped, the cutout extending into a respective section from a perimeter of the respective section positioned between the top and the bottom of the housing.

14. The power cord and electrical plug locking device combination of claim 13, wherein the lock assembly comprises a pair of tabs and a padlock, each tab being coupled to and extending from a respective section proximate to the perimeter, each tab having a hole positioned therethrough such that the holes are aligned when the housing is positioned in the closed configuration, the padlock comprising a shackle such that the shackle is positioned for insertion through the holes for securing the housing in the closed configuration.

15. An electrical plug locking device comprising:
a housing defining an interior space, the housing comprising a pair of sections, the sections being hingedly engaged such that the housing is selectively positionable in a closed configuration and an open configuration, the housing having a single cutout such that the single cutout defines an only opening into the interior space when the sections are in the closed configuration, a first end of the housing having the cutout positioned therein, wherein the configured for insertion of a cable of a power cord concurrently with a plug of the power cord being positioned between the sections facilitating manipulation of the sections to the closed configuration such that the plug is positioned in the interior space, the cutout being positioned equally distant from a front and a back of the housing and when in the closed configuration, the cutout is substantially equally distant from a top and a bottom of the housing, the cutout being substantially U-shaped, the cutout extending into a respective section from a perimeter of the respective section positioned between the top and the bottom of the housing;
a hinge engaged to and extending between the sections of the pair of sections such that the housing is selectively positionable in the closed configuration and the open configuration, the hinge being continuous type; and
a lock assembly engaged to the housing such that the lock assembly is positioned for selectively securing the housing in the closed configuration, the lock assembly comprising a pair of tabs and a padlock, each tab being coupled to and extending from a respective section proximate to the perimeter, each tab having a hole positioned therethrough such that the holes are aligned when the housing is positioned in the closed configuration, the padlock comprising a shackle such that the shackle is positioned for insertion through the holes for securing the housing in the closed configuration.
